(19) United States
(12) Patent Application Publication
(10) Pub. No.: US 2014/0227474 A1
(43) Pub. Date: Aug. 14, 2014

(54) MULTI-LAYER FABRIC, USE THEREOF AND METHOD FOR PRODUCING COMPOSITES

(71) Applicant: Johannes Cramer, Heek (DE)

(72) Inventor: Johannes Cramer, Heek (DE)

(73) Assignee: C. CRAMER, WEBEREI, HEEK-NIENBORG, GMBH & CO. KG, Heek (DE)

(21) Appl. No.: 14/119,524

(22) PCT Filed: May 18, 2012
(86) PCT No.: PCT/EP2012/002127

§ 371 Date: Jan. 31, 2014

(30) Foreign Application Priority Data
May 24, 2011 (DE) 10 2011 102 342.2

(51) Int. Cl. B32B 5/26; D06C 15/00; D06C 7/00

(52) U.S. Cl. CPC B32B 5/26; D06C 7/00; D06C 15/00
USPC 428/86; 28/122; 28/158; 28/165; 428/221; 428/220; 442/254

(57) ABSTRACT

This present invention relates to a multilayered fabric consisting of several twin layers, whereby each twin layers is constructed from two layers, namely one layer from structurally arranged reinforcement fibres Vo, Vm and Vu such as for example carbon fibres, and one layer from structurally arranged thermoplastic matrix fibres M1 and M2, such as for example PEEK fibres. Several twin layers are connected with binder fibre B. Additionally the invention comprises use of the multilayer fabric as a semi-finished product and for manufacture of composites plus a process for manufacture of composites using a special multilayered fabric with an “Advanced Synchron Weave” zero crimp fabric structure (FIG. 1).

This present invention relates to a multilayered fabric, its use as a semi-finished product and for the manufacture of composites including a process for manufacturing composites using this multilayered textile.

For many years fibre-reinforced plastic products or fibre/plastic compounds or composites have been well-known and been used in the most varied range of applications. Typically such a fibre-reinforced basic material is formed by combining a woven fibre, non-woven fabric or another form of textile fabric consisting of reinforcing threads with a plastic matrix. The mechanical and thermal properties can be adjusted, i.e. designed by an appropriate combination of reinforcing fibres and plastic matrix and by the proportion of their volume of fibre. The reinforcing fibres produce the mechanical strength value of the composite. The matrix fixes these reinforcing fibres and in this way harnesses the mechanical properties of the reinforcing fibres. A fundamental distinction is made between fibre-reinforced plastics with a thermoplastic matrix or a duroplastic resin matrix. As distinct from a duroplastic matrix a thermoplastic matrix consists of only one component, the thermoplast, which simplifies manufacture of a fibre-reinforced composite. Such a composite can additionally be subsequently reshaped and even welded. For manufacture the textile fabric, for example a carbon fibre fabric, is coated with the thermoplastic matrix, several coated textile layers laminated in a panel press and pressed to form a composite sheet under corresponding temperature and pressure conditions. In order to prevent air inclusions the equipment is evacuated if necessary. The thermoplastic matrix can also be inserted in the form of thin foils or films between the individual textile layers (film stacking) or textile layers coated with the matrix can be used.

Various processes have become established for coating the textile. For example the thermoplastic matrix can be applied in a defined quantity in the form of a powder coating to the upper side of the textile. In a sintering process these matrix powder particles bond to the reinforcing textile fibres. This process is repeated for the underside of the textile and hence a dry preliminary product (dry pre-preg) is obtained. A dry semi-finished product can also be obtained using the whirl sintering process. Here thermoplastic matrix powder particles are fluidised in a whirl bath and these powder particles then layer themselves between the filaments of the textile introduced into the whirl layer.

Liquid coating is also an option and here the thermoplastic matrix is dissolved in a solvent or dispersed and the textile fabric impregnated; then the solvent must be removed however, which is a disadvantage.

It has been shown that preliminary products produced using these familiar coating processes result disadvantageously in products which display a degree of porosity and which are not homogenous. The pores present in the composites are formed by bubbles of air, which cannot escape during production of the composite product. As the matrix also has the purpose of retaining the reinforcing fibre strands in the desired line of force, porosity in the composite product results in a changed flexural modulus of elasticity. At those points in the fibre-reinforced composite product, where there are air bubble inclusion, i.e. the reinforcing fibres are not completely embedded in the matrix, under force the reinforcing fibres can be more easily deflected, the effect of which is deterioration in quality.

To produce a conventional composite product several layers of impregnated textile fabric are layered one on top of the other and the matrix is melted under temperature. This melted matrix is squeezed through the fabric layers due to the pressure applied when pressing, whereby the air between the fabric layers and within the fabric layers are pressed out laterally, i.e. at an angle to the direction of pressure. By coating the fabric layers with each fabric layer differing conditions and differing de-aeration pathways for the air are created. In addition it cannot be guaranteed that the matrix is distributed evenly in the pressing mould, which under pressure adversely leads to dislocation of fibres from their desired position. As the reinforcing fibres are arranged along desired lines of force depending on the intended application pressing the reinforcing fibres or individual filaments away from these lines of force means a reduction of the characteristic properties of the resulting component.

It is further common do produce a hybrid yarn, i.e. a twin-component yarn from a reinforcing fibre and a thermoplastic matrix yarn and to weave this hybrid yarn to form fabric layer. Such a hybrid yarn is obtained for example by mixing and interlacing filaments of both differing materials and by spin extruding them under high pressure through a nozzle (commingling process). As the filaments in the hybrid fibres are not aligned fibre-reinforced products manufactured from fabric with these hybrid fibres have a lower flexural modulus of elasticity by comparison with the aforementioned products produced by the coating process. Document DE 42 29 546 A1 describes the possibility of providing the matrix creators in the form of fibres or yarns, in particular in the form of a hybrid yarn. In one example a fabric is produced from a hybrid yarn, which has two layers. The disadvantage is that the comparatively thick hybrid fibres can be more strongly deflected at the fibre intersections during weaving from the desired lines of force that reinforcing fibres in familiar fabrics, which additionally impairs the characteristic mechanical properties.

An additional manufacturing option for a composite product is shown in Document EP 0 392 939 B1. In this case a thermoplastic fabric structure is proposed, which can be shaped more by the effect of heat to obtain more rigid objects. This fabric structure consists of at least two superimposed fabric layers, namely one layer of reinforcing fabric and a matrix layer formed from thermoplastic fibres. By means of binder fibres every two adjacent layers are interwoven one with the other. For combination of two layers a relatively large number of interconnection points must be provided in order to prevent displacement of the layers relative to one another. At these interconnection points the reinforcement fibres are deflected from their line of force, which is disadvantageous with regard to the desired product characteristics.

The purpose of this present invention is to provide a dry preliminary product consisting of a textile structure and a thermoplastic matrix (dry thermoplastic prepreg) which can be pressed to form composites with improved mechanical characteristics.

This purpose is fulfilled with a multilayer fabric with the features listed in claim 1. A particularly advantageous multilayer fabric can be advantageously pressed as per claim 17 to form a non-porous composite. The multilayer fabric is a fabric comprising several twin layers, preferably up to 10 twin layers, whereby each twin layer consists of two different layers. The multilayer fabric therefore comprises preferably four to twenty layers. One layer of a twin layer, for example the topmost layer contains structurally arranged, equal or differential reinforcement fibres (structure formers). The other layer in the twin layer, for example the bottom layer, contains structurally arranged equal or differential thermoplastic matrix fibres (matrix formers). The binder fibres linking the layers and twin layers consist of the identical material as the matrix fibres and/or the reinforcement fibres. The binder fibres therefore bind several twin layers, preferably all the twin layers. Each twin layer therefore on the one hand contains reinforcement fibres and on the other matrix fibres.

The twin layers are so advantageously arranged that all the upper layers of the twin layers consist of reinforcement fibres and all the lower layers of the twin layers consist of matrix fibres. Depending on the number of twin layers such a multilayer textile fabric has an overall thickness of between 0.20 mm and 65 mm.

The reinforcement fibres in one layer of the twin layer form the reinforcement for the fibre-reinforced semi-finished product to be produced and are accordingly orientated to a desired direction of force. The reinforcement fibres are preferably arranged without any fibre deflection in the layer, i.e. as straight aligned warp fibres or straight aligned weft fibres or in any other desired direction, i.e. they lie without crimp in one layer of the twin layer. For these reinforcement fibres yarns, spun yarns, twisted yarns, monofilaments or multifilaments can be used. Yarn gauge here is in a range from 66 dtex and 32000 dtex. These reinforcement fibres can consist of inorganic fibres, for example carbon, ceramics such as for example glass, basalt or other silicates, silicon carbide, metals such as steel, aluminium or titanium. Reinforcement fibres can also be from organic high-tensile fibres, such as for example aramid or Kevlar or polyvinyl 2.6-benzobisoxazol (PBO), also known under the trade name Xylon, highly stretched polyethylene such as DYNEEMA or organic high-temperature thermoplasts.

The second layer of a twin layer consists of matrix fibres which melt during subsequent pressing of the invention multilayer fabric and which evenly cure and embed the reinforcement fibres. The matrix also protects the reinforcement fibres in the composite product from environmental effects. For matrix fibres of this nature yarns, spun yarns, compact yarns, continuous strand yarns, staple fibre yarns, twisted yarns, hybrid yarns in the shape of step-index fibre, thermoplastic polymer monofilaments or multifilaments can be used. If the multilayer fabric is used for manufacture of a composite to be obtained by means of a pressing process, it is preferable that multifilaments are used for the matrix fibres, as these multifilaments can act as de-aeration channels. The melting range of these matrix fibres should preferably be between 50° C. and 480° C. The gauge of the yarn here ranges between 66 dtex and 32000 dtex. Thermoplastic polymer matrix fibres are specifically from polypropylene (PP), polyethylene (PE) or even expanded polyethylene (EPE) plus fluorinated ethylene propylene (FEP), but also from polyester such as for example polyethylene terephthalate (PET), polyether sulphone (PES), polyethylene sulphide (PPS), e.g. Ryton, or polybutylene terephthalate (PBT). Also to be considered are polyamides such as for example PA 11, PA 12, PA 6.10, PA 6, PA 6.6 and PA 4.1 but also polybenzimizadol (PBI). Matrix fibres can also be from polyvinylidene chloride (PVDC), such as for example SARAN, polyvinylidene fluorides (PVDF), perfluoroxylalcan (PFA), polyetherimide (PEI) such as for example Ultem, Polytherketone (PEK) such as for example polyetheretherketone (PEEK).

Depending on the desired application for the multilayer fabric the identical or differing reinforcement fibres or identical or differing matrix fibres are used. Differing reinforcement fibres can be used within one layer. In a preferred example identical first reinforcement fibres are used in one layer and then differing reinforcement fibres are worked into another layer of a different twin layer. With a multilayer fabric with eight twin layers this means for example that the first, third, fifth and seventh twin layers of reinforcement fibres of one specification are used and the second, fourth, sixth and eighth twin layer have reinforcement fibres of a different specification, whereby the specifications can differ both with regard to the type of fibre used and with regard to the type of material. This applies similarly in the case of the matrix fibres. By using differing reinforcement fibres targeted use of reinforcement fibres is possible, in particular in order to arrive at a specific stress profile for the component to be manufactured.

For the individual layers of a multilayer fabric twin layer for structured arrangement of reinforcement fibres in a layer and for structured arrangement of matrix fibres in another layer a specific fabric structure is chosen. Depending on the desired application purpose identical or differing fabric structures are selected for the different twin layers for the multilayer fabric. The difference can consist in a different structure, i.e. different arrangement of fibres or in the case of the same structure a different fibre density. For structured arrangement of reinforcement fibres in the respective layers and for structured arrangement of matrix fibres in the other layers of the multilayer fabric the “Advanced Synchron Weave” fabric structure is preferred as described in Document EP 0 408 830 B1. However other structures besides “Advanced Synchron Weave” are possible. By selecting a specific fabric structure it can be determined in advance what quantity of matrix in the form of matrix fibres and matrix fibre density should subsequently embed a reinforcement fibre. This can be influenced by the number and thickness of the matrix fibres and/or by the number and thickness of the reinforcement fibres. Each of the structurally arranged matrix fibres in a layer is arranged in a predetermined position relative to a reinforcement fibre in the adjacent layer with the structurally arranged reinforcement fibres in the multilayer fabric.

The fibre volume ratio of reinforcement fibres in a multilayer textile multilayer fabric can be 15% to 85% and hence the matrix fibre volume ratio can be from 85% to 15%. For a non-porous, fibre-reinforced product the fibre volume ratio of thermoplastic matrix fibres is preferably 40 to 60% depending on the thickness of the thermoplast used for the matrix fibres. If using a low-density thermoplast such as polyethylene (PE) the fibre volume ratio of thermoplastic matrix fibres for example is 40% and if using a higher density thermoplast the fibre volume ratio of thermoplastic matrix fibres is more like 60%.

The multilayer fabric in this present invention may however also be used to manufacture products of a desired porosity (porous composite), which can be used for example as filters or conveyor belts. In this case a fibre volume ratio of less than 40% is chosen and a minimum fibre volume ratio of matrix fibres of 15% should be observed however in order to obtain a homogenous product.

It is also possible to select a fibre volume ratio of thermoplastic fibres greater than 60%. This means that the fibre-reinforced composite product contains more matrix than would be necessary for non-porous embedding of reinforcement fibres and it becomes the outer phase of the system. This high fibre volume ratio of matrix fibres is chosen for such products as are intended to possess a great degree of elasticity. A reinforcement fibre volume ratio of at least 15% and therefore a maximum matrix fibre volume ratio of 85% however should be observed for any meaningful use of the composite product.

Familiar weaving techniques (double faced weave technology) make it possible to produce a multilayer fabric with ten twin layers, i.e. with ten layers of reinforcement fibres and a further ten layers of matrix fibres, i.e. twenty layers in total. In a preferred design “Advanced Synchron Weave” is chosen for the individual layers in the multilayer fabric for structured arrangement of reinforcement fibres in the respective layers and for structured arrangement of matrix fibres in the remaining layers, so that in particular a multilayer fabric with a closed and smooth surface is obtained when weaving. This “Advanced Synchron Weave” non-woven structure is described in Document EP 0 408 830 B1. In this case the reinforcement fibres are arranged in the warp direction and/or weft direction, i.e. without crimp (non-woven). Given a corresponding specification profile reinforcement fibres can be arranged as both warp fibres and/or weft fibres or in another orientation—for example at a diagonal—so that these reinforcement fibres align along a desired line of force orientation. A multilayer fabric woven in this manner has an upper side on which the reinforcement fibres are visible and an underside on which the matrix fibres are visible. The binder fibres linking the several twin layers consist of matrix fibres. Here at least two twin layers are joined together by means of the binder fibres. The ratio of binder fibres in the fabric is relatively low, so that as a rule on examination of the upper side or underside of the fabric they are visible only as embedded dots. Binder fibres are preferably led through all double layers and therefore bind all layers of the multilayer fabric. For this a low binder fibre count is necessary. Despite the low binder fibre count the twin layer layers and the twin layers are not displaceable one relative to the other. Such a multilayer fabric, for example a multilayer fabric consisting of ten superimposed win layers constitutes a one-piece dry preliminary product (dry prepreg), which can be most simply—without any coating process—be pressed to form an even composite sheet. In the familiar pressing process the matrix, in this case the matrix fibre layers, are fused by application of heat. The pressing process can then be carried out in a familiar double belt press, interval press, platen press or an autoclave. The thermal energy for fusion of the matrix can be applied by contact heat, radiation heat such as HF radiation or IR radiation or by ultrasound. After matrix fibre fusion and compression of the multilayer fabric to obtain the fibre-reinforced composite product controlled cooling can be undertaken.

If such a multilayer fabric is compressed to form a composite with application of heat, the structurally arranged reinforcement fibres are embedded without any change of their orientation in the molten and re-hardened matrix. The composite has the form of a non-woven fabric formed from reinforcement fibres embedded in a matrix. The composite's reinforcement fibres lie in the desired line of force orientation without being twisted out of their effective direction as a result of the original fabric structure or manufacturing process.

Due to the structured arrangement of the matrix fibres in a chosen fabric structure, e.g. the “Advanced Synchron Weave” non-woven fabric structure, the matrix is already evenly distributed in the dry preliminary product (dry prepreg). It is precisely determined what quantity of matrix in the form of matrix fibres is to subsequently embed a reinforcement fibre. Each of the structurally arranged matrix fibres in a layer is arranged in a predetermined position relative to a reinforcement fibre in the adjacent layer with the structurally arranged reinforcement fibres in the multilayered fabric. As a result of this ideal even distribution of matrix fibres it is ensured that each filament of the reinforcement fibres is impregnated with the matrix on fusion (micro-impregnation) without pressing reinforcement fibres or filaments out of the desired line of force during pressing. In addition due to the chosen structure for the multilayer fabric, e.g. due to the fabric structure, aligned de-aeration routes are created. When using multifilaments, in particular for the matrix fibres, these additionally form, as it were, de-aeration channels.

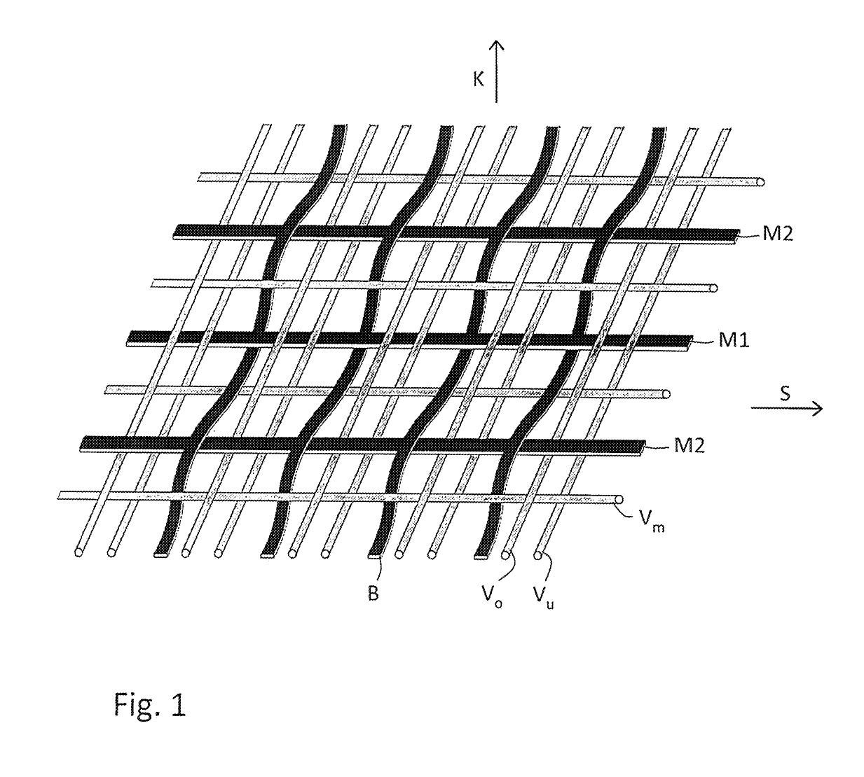

On the basis of a principle sketch below—see FIG. 1—one design of a multilayer fabric as in this present invention is described. The invention is not restricted to this one design. This is a multilayered fabric with an “Advanced Synchron Weave” with a non-woven fabric structure. The fibres sketched in are shown with an interval one relative to the other for purposes of illustration. Here matrix fibres M1, M2 are shown in weft direction S. Matrix fibres M1 here form the first layer of the first twin layer. Over it are arranged reinforcement fibres Vo, Vm and Vu of the first layer of the first layer of the first twin layer. These carbon fibre reinforcement fibres Vo, Vm and Vu are laid in straight orientation in the layer, namely upper reinforcement fibres Vo and lower reinforcement fibres Vu in warp direction K and intermediate reinforcement fibres Vm in weft direction S. Above are already indicated the second layer matrix fibres M2 of the second twin layer. The second layer of reinforcement fibres and the other twin layers are not shown so that the principle sketch remains clear. The second layer of reinforcement fibres would be situated above matrix fibres M2. Over that again is a layer of matrix fibres and over that again reinforcement fibres. Binding of all layers is by binder fibre B from polyetheretherketone (PEEK) like the matrix fibres. In total 8 matrix fibre layers of multifilament polyetheretherketone (PEEK) and 8 layers of reinforcement fibres, namely carbon monofil fibres form the “Advanced Synchron Weave” structure, a non-woven fabric structure produced on a single weaving process.

Reinforcement fibres Vo, Vm and Vu are each laid in a straight line in the layers, i.e. without crimp (non-woven) whereby a desired reinforcement fibre line of force orientation is achieved without the reinforcement fibres being deflected from this predetermined orientation. In the present non-woven fabric structure for the multilayer fabric the reinforcement fibres in particular are as it were introduced into the fabric structure in the form of a non-woven fabric and all the layers are woven to form the multilayer fabric. Nor does the arrangement of reinforcement fibres change when pressing such a multilayer fabric to form a composite. If such a multilayer fabric is placed in a press and compressed to form a flat composite, the reinforcement fibres retain their straight alignment, namely in warp direction K on the one hand and weft direction S on the other. During a pressing process the PEEK thermoplastic matrix fibres melt, impregnate the carbon fibres and after cooling carbon fibre reinforcement fibres Vo, Vm and Vu are in the same straight alignment as warp fibres Vo, Vu and Vm of the original non-woven fabric now embedded as a layer in the PEEK matrix.

On the other hand should an unevenly shaped component be produced, for example a curved composite sheet, during pressing the same curved shape is formed, if the press tools are shaped accordingly. For this the flexible multilayer fabric is so draped when inserting in the press that the reinforcement fibres are in the desired orientation, namely no longer straight but in this case are aligned in a curve in order for them to adopt this orientation in the finished component.

Such a component possesses an extremely high degree of homogeneity and practically no detectable porosity to the extent that it can be designated non-porous.

These fabrics which are the subject of the present invention are also particularly advantageous for production of shaped fibre-reinforced composite products such as convex or concave sheets or three-dimensional components, as the multilayer textile fabric can be easily draped in a mould. A flat composite sheet can also be subsequently reshaped due to the thermoplastic matrix. In addition on the basis of choice of reinforcement fibres in a multilayer fabric, the properties of the fibre and the fabric structure any desired rigidity can be locally designed in a targeted manner.

In further developments of the invention it is planned to work additional reinforcement fibres into an intermediate layer, for example between the two layers of the twin layer as so-called pile fibres. In this way the stress profile for the desired fibre-reinforced semi-finished product can be additionally reinforced in the desired direction of the reinforcement fibres used as pile fibres are aligned in the direction of the desired lines of force.

Targeted design of fibre-reinforced hybrid components is also possible therefore due to the invention's multilayer fabric, namely on the basis of the choice of differing reinforcement fibres or matrix fibres in a twin layer or in differing twin layers by providing pile fibres between the layers of a twin layer or by an additional single layer as an intermediate layer between two twin layers or as a finishing layer.

Fibre-reinforced composites manufactured in this way can be used as the outer skin for aircraft, automobiles or other vehicles. Three-dimensional shaped composites produced from this multilayer fabric can be used for example as moulded parts for acid pumps, artificial limbs, sports goods or as structural components for vehicles. The advantage of these composites is their light weight, their chemical resistance and their good mechanical properties and amongst other things a comparatively higher flexural modulus of elasticity can be achieved than is the case with composites from hybrid yarn.

The use of the new multilayered fabric as a semi-finished product in the manufacture of fibre-reinforced composite parts has the advantage that after manufacture of the multilayered fabric no coating process is any longer necessary as the matrix fibres are already integrated due to weaving the multilayer fabric into the textile product. Such a multilayer fabric can therefore be formed without any coating process, without producing a hybrid fibre or a matrix film and can be placed directly into a suitable mould. During fusion of the matrix fibres the multilayer fabric is shaped and compressed to form the desired fibre-reinforced composite component. Therefore in manufacture or a fibre-reinforced composite component one work step, for example, the coating process is saved.

The multilayer fabric is a dry preliminary product which has good storage properties and which remains stable in storage in respect of its constituent components. Of particular advantage with the multilayer fabric which is the subject of this invention targeted matrix distribution is possible due to even distribution and structural arrangement of matrix fibres and targeted arrangement of reinforcement fibres in the composite—this due in particular to the zero crimp introduction of the reinforcement fibres. During pressing of the semi-finished product, namely the multilayer textile fabric which is the subject of this invention rapid heat transfer and an ideal level of de-aeration is achieved; air inclusions are prevented. Even distribution of the matrix in the form of the structured arrangement of matrix fibres relative to the reinforcement fibres results in the finest degree of micro-impregnation of individual reinforcement fibre filaments by the molten matrix. With the specific matrix melt flow during pressing of the multilayer fabric the subject of this invention any deflection of reinforcement fibres from the ideal line of force is avoided and an improved composite product obtained thereby.

1. A dry thermoplastic prepreg for the manufacture of composites, comprising a multilayer fabric comprising reinforcement fibres and thermoplastic matrix fibres arranged in a plurality of textile twin layers,
wherein each twin layer consists of two layers, namely one layer of structurally arranged identical or differing reinforcement fibres and one layer of structurally arranged identical or differing thermoplastic matrix fibres and whereby each of the structurally arranged matrix fibres in a layer is arranged in a predetermined position relative to a reinforcement fibre in the adjacent layer, the layers of the twin layers are joined one to the other by binder fibres fed through at least two twin layers, and the twin layers are not displaceable one relative to the other.

2. The dry thermoplastic prepreg of claim 1, wherein up to 10 twin layers are provided, whereby the total thickness of the multilayer fabric is between 0.20 mm and 65 mm.

3. The dry thermoplastic prepreg of claim 2, wherein the identical reinforcement fibres and the identical arrangement of reinforcement fibres is used for one layer of each twin layer and the identical matrix fibres and the identical arrangement of matrix is used for the other layer of each twin layer.

4. The dry thermoplastic prepreg of claim 2, wherein different reinforcement fibres and/or different arrangement of reinforcement fibres is used for one layer of the twin layers and/or different matrix fibres and/or different arrangement of matrix fibres is used for the other layer of the twin layers.

5. The dry thermoplastic prepreg of claim 1, wherein reinforcement fibres are yarns, spun yarns, compact yarns, continuous yarns, staple fibre yarns, twisted yarns, monofilaments or multifilaments with yarn gauges from 66 dtex to 32000 dtex and which consist of carbon, ceramics such as for example glass, basalt or other silicates, silicon carbide, metals such as steel, aluminium or titanium, aramid such as for example Kevlar, polyphenylene-2.6-benzobisoxasol (PBO) such as for example Zylon, highly stretched polyethylene such as DYNEEMA or organic high-temperature thermoplasts.

6. The dry thermoplastic prepreg of claim 1, wherein the matrix fibres are yarns, spun yarns, compact yarns, continuous yarns, staple fibre yarns, twisted yarns, monofilaments or multifilaments with yarn gauges from 66 dtex to 32000 dtex and consist of thermoplastic polymers with a melting point in the range between 50° C. and 480° C., preferably polypropylene (PP), polyethylene (PE), also for example expanded polyethylene (EPE) or fluorinated ethylene propylene (FEP), polyester, polyether sulphones (PES), polyphenylene sulphides (PPS, e.g. Ryton), polyethylene terephthalates (PET), polyamides (PA), polyphenyl sulphide (PPS), polyvinylidene chlorides, (PVDC, e.g. Saran), polyvinylidene fluorides (PVDF), perfluoroxylalcanes (PFA), polybenzimidazol (PBI), polyetherimides (PEI, e.g. Ultem), polyetherketone (PEK) such as for example polyetheretherketone (PEEK).

7. The dry thermoplastic prepreg of claim 1, wherein a fabric structure is chosen for the layers, which results in a closed and smooth surface, in which the reinforcement fibres are arranged in straight alignment in the respective layer as warp fibres and/or weft fibres.

8. The dry thermoplastic prepreg of claim 1, wherein the binder fibres consist of the same material as the reinforcement fibres and/or the matrix fibres.

9. The dry thermoplastic prepreg of claim 8, wherein the binder fibres are multifilament fibres and consist of the same material as the matrix fibres.

10. The dry thermoplastic prepreg of claim 1, wherein the layer with the reinforcement fibres has a fibre volume ratio of 15% to 85% and the layer with the matrix fibres has a fibre volume ratio of 85% to 15%.

11. The dry thermoplastic prepreg of claim 1, wherein between the two layers of at least one twin layer, pile fibres are incorporated, whereby the pile fibres consist of matrix fibres or reinforcement fibres.

12. The dry thermoplastic prepreg of claim 1, wherein between the twin layers, at least one intermediate layer of matrix fibres or reinforcement fibres is provided.

13. Use of a multilayer fabric as per claim 1 as a semi-finished product.

14. Use of a multilayer fabric as per claim 1 for manufacture of non-porous, lightweight, flat, convex or concave composites such as for example sports goods, acid pumps or artificial limbs, specifically with a reinforcement fibre volume ratio of 40% to 60%.

15. Use of a multilayer fabric as per claim 1 for manufacture of shaped, non-porous, lightweight components, such as for example of an automobile component, car wing, fender, prop shaft cover, specifically with a fibre volume ratio of 40% to 60%.

16. Use of a multilayer fabric as per claim 1 for manufacture of porous products for use as a filter or as conveyor belts, whereby specifically the matrix fibre volume ratio is between 15% and 40%.

17. A process for the manufacture of non-porous lightweight composites comprising the steps of:
manufacturing a multilayer fabric, comprising several twin layers, whereby one twin layer per layer includes one layer of aligned reinforcement fibres structurally arranged but without binding and one layer each of structurally arranged thermoplastic multifilament matrix fibres and where all layers are connected by binding fibres;
introducing the multilayer fabric into a press, whereby the reinforcement fibres adopt a predetermined orientation;
subsequent heating of the textile multilayer fabric to a melting temperature commensurate with the flow range of the matrix fibres, whereby under pressure the multilayer fabric is compressed to form an homogenous, compact fibre-reinforced composite and which can be shaped and whereby air enclosed in the multilayer fabric escapes; and
cooling the compound to obtain the desired composite, in which the reinforcement fibres provided in the predetermined orientation are embedded in the thermoplastic matrix formed in the matrix fibre material in the form of a non-woven layer.

18. The process of claim 17, wherein the press is a double belt press or interval press, platen press or autoclave.

19. The process of claim 17 wherein heating by application of energy is by contact heat, radiation heat such as for example HF radiation or IR radiation or ultrasound.
